(19) United States
(12) Patent Application Publication
(10) Pub. No.: US 2020/0062245 A1
(43) Pub. Date: Feb. 27, 2020

(54) METHOD OF PROVIDING FOR THE DYNAMIC STABILITY AND SAFETY OF A VEHICLE AND DEVICE FOR THE IMPLEMENTATION THEREOF

(71) Applicant: LIMITED LIABILITY COMPANY "INNOVATIVE CENTER JEWEL", Voronezh (RU)

(72) Inventors: Nikolay Andreevich SAMOTSVET, Voronezh (RU); Vladimir Pavlovich LIHACHEV, Voronezh (RU); Sergei Nikolaevich PANYCHEV, Voronezh (RU); Leonid Borisovich RYAZANTSEV, Voronezh (RU); Dmitry Andreevich SAMOTCVET, Voronezh (RU)

(73) Assignee: LIMITED LIABILITY COMPANY "INNOVATIVE CENTER JEWEL", Voronezh (RU)

(21) Appl. No.: 16/462,566

(22) PCT Filed: Dec. 2, 2016
(86) PCT No.: PCT/RU2016/000843

§ 371 Date: May 21, 2019

(30) Foreign Application Priority Data
Nov. 30, 2016 (RU) 2016147027

(51) Int. Cl. B60W 30/09; G06K 9/00; G06T 7/70; G06T 7/60; G06T 7/20; G05D 1/00; G01S 13/86; G01S 13/93; G01S 13/90

(52) U.S. Cl. CPC B60W 30/09; G01S 2013/9392; G06T 7/70; G06T 7/60; G06K 9/00805; G06T 7/20; G05D 1/0088; G05D 1/0061; G01S 13/867; G01S 13/931; G01S 13/90; G06T 2207/30256; G06T 2207/10044; G06T 2207/30241; G05D 2201/0213; B60W 2420/42; B60W 2420/52; B60W 2520/10; B60W 2550/10; G01S 2013/9382; G06K 9/00798

(57) ABSTRACT

The invention relates to road traffic safety technology, and more particularly to intelligent transportation systems and vehicle-based means for viewing the space in the front lateral region of a vehicle and for keeping a vehicle in a given traffic lane. A method of providing for the dynamic stability and safety of a vehicle comprises the steps of acquiring an image by means of a video camera and a synthetic-aperture radar, assessing the presence of a marking or road stripe, forming a digital radar image and/or a radio-frequency hologram of the road and of objects situated on the verges to the right and left of the road, determining the boundaries of the road, detecting the position of the vehicle, determining the vector velocity of the movement of the vehicle, extrapolating the path of travel of the vehicle taking into account the current vector velocity, calculating the potential occurrence of an emergency event on the basis of the aforementioned extrapolation, and activating the safety means of the vehicle on the basis of the aforesaid calculation. The technical result is that of providing for the dynamic stability of a vehicle in difficult weather conditions.

### FIELD OF THE INVENTION

The invention relates to road traffic safety technology, and more particularly to intelligent transportation systems and vehicle-based means for viewing the space in the front lateral region of a vehicle and for keeping a vehicle in a given traffic lane.

### STATE OF TECHNOLOGY

There are an optical method and a device for monitoring the traffic lane of a vehicle, for example, US patent «System and method of control of vehicle traffic lane» [1]. There is also known a method of assisting in an automobile traffic lane [2], which is implemented in a system for holding the motion traffic lane. This method-analog is based on monitoring the output of an automobile from a lane on a roadway with a properly marked mark. Monitoring of the current position of the vehicle on the roadway is carried out by reading a side mark a lane of motion using a television camera installed on board. At the output of the vehicle from the traffic lane, a warning signal is supplied to the driver. The principle of the operation of the system is shown in FIG. 1.

The disadvantage of the method-analogue is the dependence of the system's working capacity from the weather conditions and the time of day. If the visibility is poor, the system does not work. In addition, the system works only on roads with clearly and correctly applied lateral marking lines. The range of the system is small and is limited by the technical capabilities of the video camera (up to 60 m under simple meteorological conditions). Icing and fogging of lens chamber results in loss of its working capacity.

A device is known for assisting in the movement of an automobile lane [3]. This device not only alerts the driver about the exit from the lane but also actively cuts the vehicle.

The movement-assisting device is an electronic system and includes a control key, a video camera, control unit and actuating mechanisms. System is switched on by means of a control key.

The video camera records the image at a certain distance from the vehicle and its digitization. The system employs a monochrome camera that recognizes the marking lines as a sharp change in gray scale. The camera is combined with the control unit. The actuating devices of the system with the aid of motion in the lane are a control lamp, an audio signal, a vibration motor on a steering wheel, an electric motor of an electromechanical steering wheel.

The information about the operation of the system is output to the instrument panel by means of a check lamp. Warning of driver is carried out by means of vibration of steering wheel, as well as supply of visual, audio and light signals. The vibration is produced by a vibration motor built into the steering wheel.

The motion path is corrected by forced steering of the steering system by means of an electromechanical steering booster (most systems) or by slowing down wheels on one side of a vehicle (Lane Departure Prevention system).

During the operation of the active system by means of the lane motion, the following main functions are realized:
motion lane path recognition;
visual informing about system operation;
motion path correction;
driver warning.

The situation before the vehicle is projected onto the photosensitive matrix of the camera and is transformed into a black-and-white image, which is analyzed by an electronic control unit.

The algorithm of operation of the control unit determines the position of the lines of the marking of the strip, evaluates the quality of the marking recognition, calculates the width of the lane and its curvature, calculates the position of the vehicle on the lane. On the basis of the calculations performed, the steering action on the steering gear (brake system) is performed, and if the required effect of holding the vehicle on the lane is not reached, the driver is warned (vibration of the steering wheel, sound and light signals).

It should be noted that the amount of torque applied to the steering mechanism (braking force on two wheels on one side of the vehicle) is small and can be overcome at any moment by the driver.

The analog device has the following disadvantages: under adverse conditions (the absence of one line or the entire marking, contaminated or snowy road, narrow lane, non-standard marking at repaired portions, rotation of small radius), the system is deactivated. None of the known analogs provides control of the exit from the lane under complex meteorological conditions, under conditions of absence of road marking, on the route from snow and ice.

The closest to the proposed method of ensuring the directional stability of an automobile (the prototype method) is the method realized in the system by the help of motion in the lane [4]. This system helps the driver to prevent emergency situations by monitoring the selected lane of motion. The system prevents the driver from deviation from the selected motion lane.

The lane motion assist system operates in the following manner. The current situation before the vehicle is projected onto the light-sensitive matrix and transformed into a black-and-white image, which is analyzed by an electronic control unit. The algorithm of operation of the control unit includes operations of determination of the position of the lines of marking of the lane, calculation of the width of the lane and its curvature, calculation of the position of the automobile on the lane.

Thus, the operation of the active lane-movement system includes the following main functions: motion-lane path recognition; visual informing of the driver about the operation of the system; correction of the motion path; warning of the driver.

The disadvantage of the above-described method-prototype is its low efficiency in the conditions of complex meteorological environment on roads. Another disadvantage of the prototype system is the limited radius of operation of the video camera and the dependence of the quality of its operation on the presence and contrast of road marking strips, full nonoperability of snow and ice on roadway.

System, known from source [4], prevents driver from deviation from selected lane and provides control actions to steering wheel and wheels of automobile. The system includes the following basic elements:
digital video camera;
control unit;
actuating devices.

The video camera records the image at a certain distance from the vehicle and converts it into digital form. The video camera is connected to the control unit via the digital data bus. The control unit on the basis of processing of the information supplied from the video camera monitors the trajectory of the vehicle movement and generates commands to the actuating devices when the vehicle deviates from the movement along the selected strip. Actuating devices include vibration devices, signal lamps and sound signals for indication of dangerous deviation.

The disadvantage of the prototype device described above is the limited radius of operation of the video camera and the dependence of the quality of its operation on the presence and contrast of road marking strips and weather conditions, and also complete inoperability in the presence of snow and ice on the roadway.

### DESCRIPTION OF THE INVENTION

The declared invention is aimed at increasing the safety of road traffic under complex meteorological conditions and in the absence or violation of road marking on the roadway. This aim is achieved in that a new principle of determining the position of a vehicle on a road in motion is used. Unlike the prototype method, the initial information for determining the position of a vehicle on a given lane is the radar contrast between reflections from the road bed, and reflections from local items in the front hemisphere of a moving vehicle (on the right and left sides of the road from the roadway). The contrast corresponds to the border between the road and the roadside and makes it possible to determine the width of the road, its curvature, as well as the presence of obstacles on it. The processing of the radar image makes it possible to accurately determine the current location of the vehicle on the road by two spatial coordinates and analyze the course of motion of the vehicle (including by extrapolation of the trajectory) and its deviation from the optimal (safe) course of motion.

The aim of the invention is achieved by the fact that in the method of providing the directional stability and safety of the movement of a motor vehicle, the steps are carried out, in which:
an image of roadway is obtained;
the presence of marking on the road surface is analysed, and if it is present, the data about it is processed;
the positions of the marking lines or the edge points of the roadway are recognized;
the width of the lane or the area of the road surface intended to move the vehicle and the curvature of the said strip and the area of the road bed are calculated;
the calculation of the position of the vehicle on the current road lane or the region of the road bed is carried out;
radar probing of front-side hemisphere of sector is performed before automobile with high resolution in course of motion by means of onboard radar with synthesized aperture;
a digital radar image (radar) and/or a radio hologram of the road and objects located on the shoulders on the right and left of the road bed are formed;
automatic recognition is performed on radar and/or radio-hologram of boundary between road and roadside by means of analysis of reflected signals in collinear and cross polarization;
the vector speed of the automobile motion is determined;
trajectory of motion of automobile is extrapolated with consideration of current vector speed;
an assessment of the occurrence of an emergency event is calculated on the basis of said extrapolation;
the vehicle security means is activated based on said evaluation.

The aim of the invention is also achieved by means of a device for providing the heading stability and safety of an automobile which comprises a control panel, a digital video camera, data exchange unit with onboard computer, microcontroller, control unit, interface unit with actuating devices, signaling means, vehicle safety means, wherein the data exchange unit with the on-board computer is simultaneously coupled to the control panel, the microcontroller and the control unit, and the microcontroller via the digital data bus is coupled to the digital video camera and the control unit, whose output via the interface unit with the actuating devices is connected to the actuating devices representing the means of signaling and safety of the vehicle, characterized in that the device is additionally provided with a Radar with a synthesized aperture, the output of which is connected to the bus of digital data transmission with the microcontroller, a vehicle safety means such as a mobile communication means, an emergency alarm and an autopilot is additionally connected to the interface unit with the actuators, the microcontroller being capable of processing data received from the video camera and the onboard Radar, on the basis of which the calculation of the vector speed of motion of the automobile is carried out, performs extrapolation of the trajectory of the vehicle movement taking into account the current vector speed, calculation of an assessment of the occurrence of an emergency event on the basis of said extrapolation and activation of the vehicle security means on the basis of said evaluation.

In one of the specific versions of the claimed method there is additionally indicated the current position of the vehicle and the result of extrapolation of the trajectory of its movement on the display of the electronic device.

In another particular version of the claimed method, the obstacles on the roadway are additionally displayed.

In another particular version of the declared method, when analyzing the presence of obstacles, the traffic lanes of the associated and opposite direction and the area of the roadside are taken into account.

In another particular embodiment of the claimed method, the electronic device is a head multimedia device of a vehicle.

In another particular embodiment of the claimed method, the electronic device is an electronic mobile device.

In another particular embodiment of the claimed method, the mobile device is a smart phone or a tablet or laptop computer.

In another particular embodiment of the claimed method, the image on the display of the head multimedia device of the vehicle duplicates information about the trajectory of the vehicle movement, and also on the road of obstacles on the electronic mobile device.

In another particular embodiment of the claimed method, an emergency event is an unintentional movement of the vehicle into the area of the roadside or the likelihood of collision with an object or a drift.

In another particular variant of the claimed method depending on type an emergency event is activated by an auto-pilot or emergency braking, or an anti-skid system, or an automobile emergency alarm or a combination thereof.

In another particular embodiment of the claimed method, when activating the autopilot, a system for holding an automobile in a traffic lane or a portion of a road surface of a motor vehicle is activated.

The essence of the proposed method of ensuring the directional stability of a motor vehicle consists in realization of the new technology of obtaining information for determining the optimal lane of motion. All information required for this purpose provides for procedure of radar probing of front-side area of space in front and right-to the left of vehicle with high resolution of probing objects. High resolution provides a radar with a synthesized aperture. The reflections from the homogeneous roadway are significantly different from reflections from local items on roadside. The nature of the reflections from the road surface is essentially specular, while the nature of the reflections from the local objects on the roadside is predominantly diffuse. A large number of vertically-extending objects are arranged along the roads (guard, column, bush, trees). The level (intensity) of reflection from them of the probing signal of the radar will be greatest if the polarization of the emitted radar signal will be collinear (vertical). At the same time, the reflection intensity from the roadway will be minimal. The use of this feature makes it possible to accurately recognize the boundaries of the roadway due to the abrupt change in the intensity of the received reflected signals from the road and from the local items on the roadside.

The technical result of the proposed method and the device for its realization consists in the fact, proposed technical solutions provide stability of automobile under complex meteorological conditions, including on roads with missing or broken road marking, due to increased accuracy of identification of road sections and objects in such areas, which can lead to emergency situation in motion of vehicle.

Resolving power of modern digital small-sized and cheap radars with synthesized aperture is one-tens of centimeters, real makes it possible to define boundary between road and shoulders with precision up to 10-50 cm. The software technologies developed by the author of the invention make it possible to simply analyze the digital radar images obtained by the radar with the synthesized aperture, and to determine the exact current position of the vehicle on the road bed, the presence of dangerous obstacles, and also to obtain initial information for calculation of safe trajectory of automobile movement for prevention of spontaneous displacement to side of roadside, lane with threat of occurrence of dangerous situation on the side of other participants of motion (for example, accident) or prevention of drift during motion to complex meteorological conditions (sediments, dark time of day, fog, side wind, etc.). The synthesized aperture Radar can also be used to create a radar holographic image which can be displayed on a multimedia system, installed on a vehicle or broadcast to the electronic device of the user (smart phone, laptop computer, monitors of headrest, etc.).

Essence of the claimed device consists on the basis of the obtained Radar or radio hologram of the transmitted-side space and the results of its program processing are launched into the action of the device for providing the directional stability and safety of the automobile: signaling means, steering and braking system, auto-pilot, alarms.

### BRIEF DESCRIPTION OF THE DRAWINGS

FIG. 1 illustrates the principle of LDW operation.

FIG. 2 illustrates the main steps of the claimed method of vehicle heading stability.

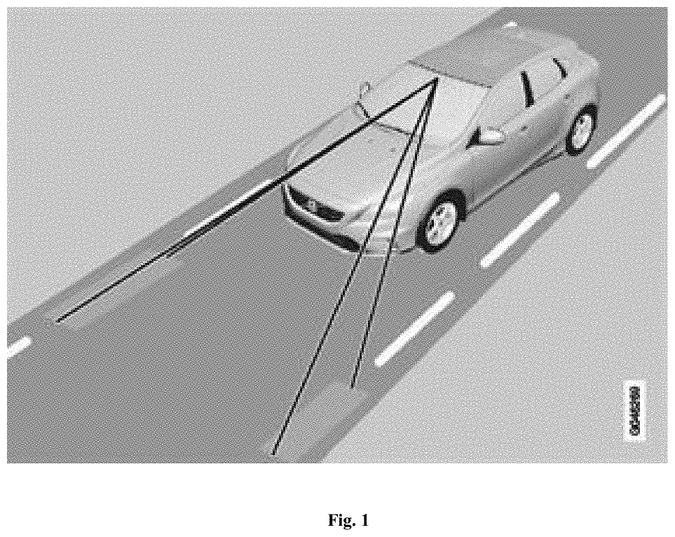

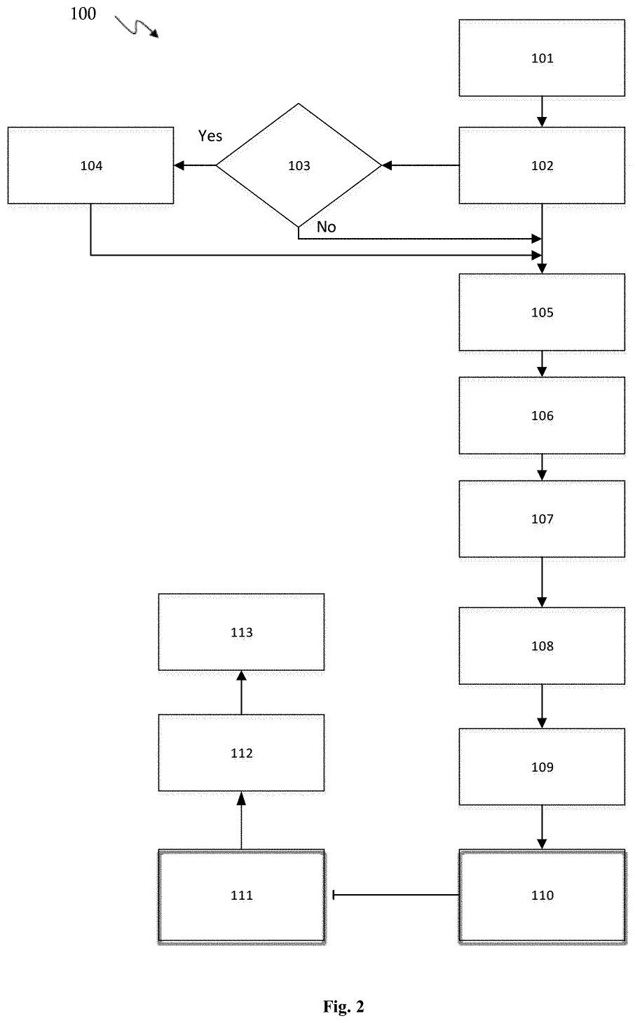

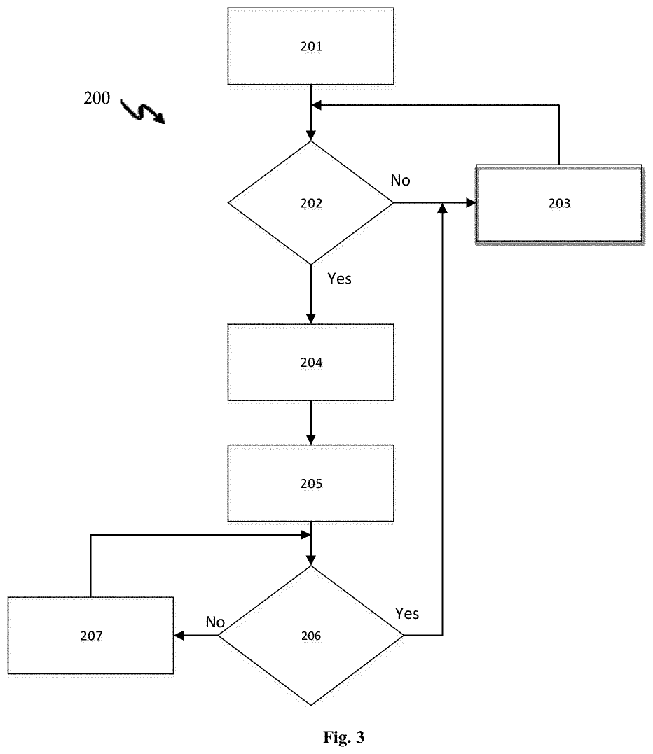

100—Basic operations of the claimed method;

101—Roadway image acquisition;

102—Analysis of the presence of marking on the roadway;

103—Marking is revealed?;

104—Production of road marking data;

105—Radar probing of front hemisphere ahead of vehicle;

106—Formation of a radio-hologram and a radar image;

107—Recognition of the border of the roadside and/or the traffic lane of the vehicle;

108—Data acquisition of road surface area;

109—Calculation of vehicle position;

110—Calculation of vehicle location relative to obtained borders of road bed;

111—Extrapolation of trajectory of automobile movement taking into account current vector speed;

112—Calculation of an emergency event estimate;

113—The activation of the vehicle safety equipment.

FIG. 3 illustrates an analysis of the occurrence of an emergency event during vehicle motion.

200—Algorithm for analyzing probability of occurrence and type of emergency event.

201—Assessment of the occurrence of an emergency event.

202—Is an emergency event coming?

203—Continuation of the evaluation of the traffic situation.

204—Determination of emergency event type.

205—Activation of the corresponding required vehicle safety means.

206—Normal motion of the vehicle is restored?

207—Activation of the corresponding required vehicle safety means.

FIG. 4 illustrates a schematic diagram of the claimed device for providing the directional stability of a motor vehicle.

300—Circuit and principle of operation of claimed device;

301—Control panel;

302—Unit for exchanging data with an onboard computer;

303—Digital video camera;

304—Microcontroller;

305—Control unit;

306—Synthetic-aperture radar;

307—Unit for interfacing with slave devices;

308—Automobile safety means;

3081—Autopilot;

3082—Emergency signaling;

3083—Steering control;

3084—Braking system;

3085—Mobile communication means;

309—Automobile signaling means;

3091—Light warning signals;

3092—Sound signaling;

3093—Mechanical signaling.

FIG. 5 illustrates an example of implementation of the claimed method and device.

FIG. 6 illustrates an example of information, obtained in the scanning of the road area.

### DETAILED DESCRIPTION OF THE INVENTION

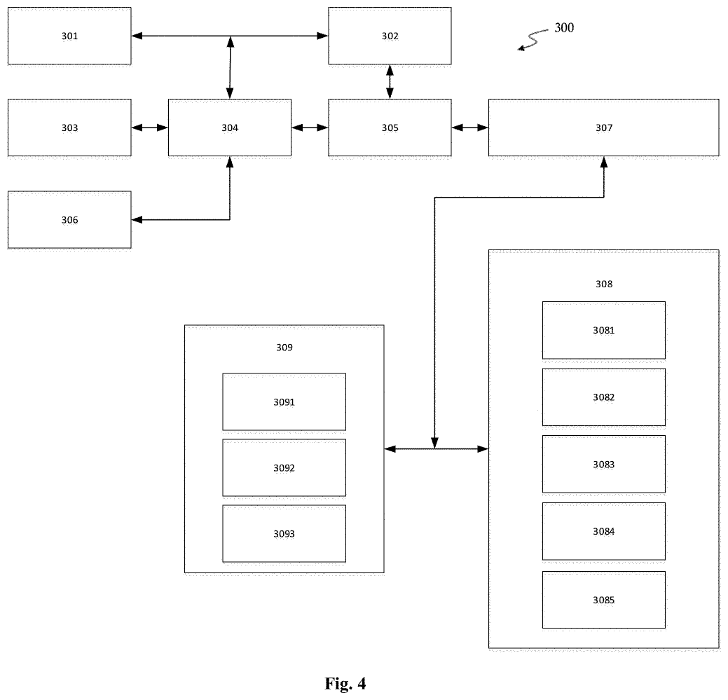

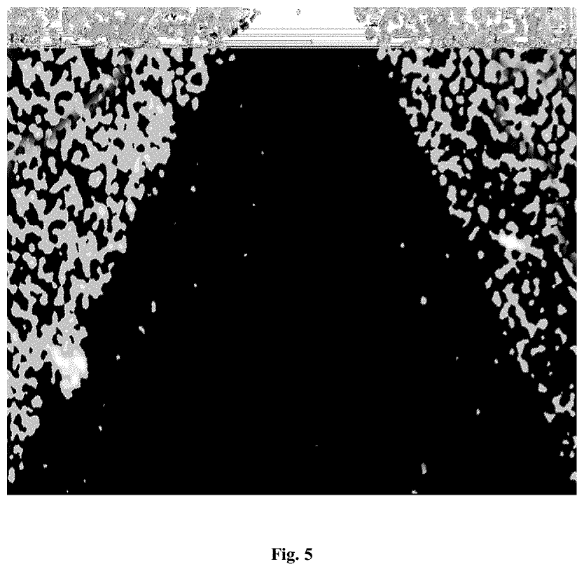

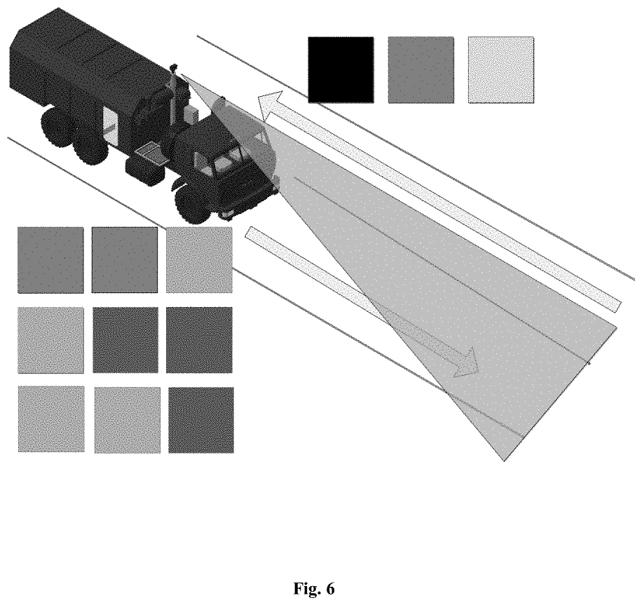

According to FIG. 2, the proposed method (100) includes the following operations:

In steps (101), an image of a road and adjacent territories (roadsides, zones not intended for driving motor vehicles) is obtained, which is carried out by means of a digital camera mounted on board of the vehicle and a radar with a synthesized aperture. Radar probing of the front-side hemisphere along the course of the vehicle is carried out by means of the radar.

In step (102), the acquired road traffic data is analyzed by the embedded algorithm in the computer system of the vehicle for the presence of a road marking, which allows determining the road type (line, two-, three-lane road, etc.). At block (103), the received data is processed to identify the marking and, if it is determined (step 104), then further determination of the position of the vehicle on the road is carried out taking into account this data.

By means of the mentioned radar, at step (105) a scanning of the front-side area in direction of movement of the vehicle and reception of reflected signals is performed. Radar is made double-polarized (bipolarized) with synthesized aperture and allows to create a polarization matrix of road conditions, which probes the specified area of space and provides information necessary to ensure directional stability and safety of the vehicle. Stability is provided by providing the driver with information about the current position of the vehicle on the roadway, and safety—with a set of warning signals and control actions that make up the essence of the invention.

In step (106), on the basis of the received data from the digital camera and the radar, a digital radar image and/or radio holograms of the road and local objects are formed on the roadside to the right and left of the roadbed, which allows determining the situation in the direction of movement of the vehicle.

On the basis of the detected area of the roadway and the areas of the shoulders, with the help of the radar images and/or hologram, in the step (107) an automatic recognition of boundary between road surface and roadside is performed, or determination of total number of motion lanes (both in way of vehicle motion and on the opposite side) is performed.

In step (108), a detailed information on the status of the roadway is obtained, which may include determining a road type, presence of asphalt, presence of other lanes of motion, zones of the roadside, objects on shoulders, presence of baffles, dividers, etc.

Based on the information obtained at step (108), the current position of the vehicle is determined in step (109), in particular, the lane or position relative to the zone of shoulders (roadside), other vehicles (objects) in the case the vehicle moves along a country road, or a road with the absent asphalt pavement, or in meteorological conditions that complicate the analysis of the lane (snow, glaciation). At this step, the determination of the lane width or area of the road in the direction of the vehicle, and its curvature, is performed.

Next, in step (110), calculation of the vehicle vector speed is calculated. Then, in step (111), on the basis of the speed vector determined in step (110), an extrapolation of the motion path of the vehicle is performed.

Based on the extrapolation obtained in step (112), an estimate of the onset of an emergency event is calculated, that is, an event that may lead to involuntary displacement of the vehicle from the lane of its motion, an involuntary displacement into the curb zone, a vehicle drift, collision with an object.

Depending on the calculated estimation of the probability of the occurrence of the event or other event, activation of the security means of the vehicle is performed (step 113), in particular the steering system, braking/emergency braking system, alarm or warning systems for attracting attention of a driver, autopilot, emergency message system with a help of mobile communication device installed in vehicle.

The term “involuntary displacement” refers to the likelihood of an unauthorized loss of vehicle control due to deterioration of health conditions of the driver, changing into a traffic lane without turning on the turn signal, for example, loss of contact with the steering wheel, loss of driver concentration or falling asleep, etc.

FIG. 3 explains the probability analysis method and the emergency event type (200).

First, an estimate of the probability of occurrence of the event type is obtained (201). Then in step (202) the event type analysis is performed with its subsequent determination (step 204). After it is determined in step (204), the necessary one or combination of the safety means of the vehicle is determined (step 205), the use of which stabilizes the normal, safe movement of the vehicle.

At step (206), the vehicle system determines the current vehicle position when one safety means is activated, and if the normal movement of the vehicle is not restored, the activation of an additional security means takes place, after which the analysis of the vehicle position is repeated. Such a situation, for example, may be in the case of an activation of an autopilot or a firing system in complex weather conditions (rain, snow) with the appearance of a skid, in this case, it is necessary to perform activation of at least two safety means to resume normal movement of the vehicle.

In addition, the position information of the vehicle, the lane(s) of traffic, the objects on the roadside, possible obstacles on the road or the roadside (presence of other vehicles, pedestrians, cyclists, potholes, puddles, etc.) may be displayed on the display of the electronic device. Such a device may be, for example, a head device built into a vehicle (multimedia device), a driver's mobile device (tablet, phone, notebook, etc.) or displays built into automobile headsets. The result of the previously performed extrapolation may also be displayed. Said information can also be translated at the same time as on displays mounted in a vehicle (head device, headsets displays) as well as to mobile devices of users (for example, by means of signal broadcast by Miracast technology).

To warn the driver, it is also possible to use alarm means, in particular sonic, light, mechanical. At high probability of occurrence of emergency event, activation of automobile dynamics is performed with generation of warning signals or special buzzer; activation of lighting devices of saloon (lamps, diodes); activation of mechanical action in the form of vibration of steering wheel, and/or the handle of the gearbox, and/or the seats of the driver and/or passengers.

FIG. 4 is a schematic diagram of the claimed device (300) for providing the directional stability and safety of a motor vehicle, which operates as follows.

The operation of the described device is triggered via the control panel (301) by means of control keys. The digital video camera (303) operates as described in the prototype device.

Introduced into composition of claimed device, the digital radar with a synthesized aperture (306) generates probing signals and receives reflected signals at a distance of up to two kilometers in the front-side angular sector. The received radar signals are transmitted via the digital data transmission bus to the microcontroller (304), where, in accordance with the programmed algorithms, a radar image (XRD) and/or a radio-hologram of a given probed area of the space is generated. In the microcontroller (304), in accordance with the algorithms in place, the current radar image and/or the radio hologram is processed. The contrast image in the matrix digital form from the microcontroller (304) via the digital data transmission bus is supplied to the control unit (305).

The data exchange unit (302) with the vehicle on-board computer provides coordinated operation of the control panel (301), the microcontroller (304) and the control unit (305).

In the control unit (305) according to special algorithms for processing data obtained from the radar and the digital camera, and executed by the microcontroller (304), the boundaries of the roadway are automatically determined, dangerous obstacles are detected, the current position and speed of the vehicle and the trajectory of its movement are calculated taking into account lead prediction. The control unit (305) also generates commands for controlling the operation of the actuators, which are safety means (308) and vehicle signaling means (309). These commands are supplied to the interface unit with executive devices (307), where they are transformed into a form suitable for actuating the vehicle actuators for prevention of dangerous situations (unexpected lane departure, skidding, probability of a collision with an object, etc.).

The interface unit with the actuating devices (307) transmits the control actions to the actuators of the safety means (3081)-(3085) and signaling means (3091)-(3093) depending on the type of instructions received from the control unit (305).

The mobile communication means (3085) of the vehicle may be based on a standard cellular telephone, GSM Modem, GPS-tracker, or a combination thereof, which may automatically transmit information about the location of the vehicle, to transmit the emergency alert signals to the rescue services, transmit coordinates of the vehicle and so on. In the event of an accident or a breakdown of a motor vehicle, in which no further movement is possible, with an aid of said means (3085), the signals can be transmitted immediately after the occurrence of such an event or is forced by the control panel (301) of the device (300).

Verification of the invention concept was carried out by full-scale prototyping. In LLC “IC Jewel”, in the context of startup—project's realization, a model of the radar with the synthesized aperture of the C-range is made and tested. An example of a graphical image of the front-side sector according to the results of the radar probing is shown in FIG. 5. The algorithms for processing the radar image and displaying the trajectory of the vehicle motion were debugged. Based on the publicly available and widely used Intel Edison programmable platforms, the possibility of transmitting data from the control unit to the actuators was checked.

The efficiency of the claimed method and device is influenced primarily by the quality of recognition of the border between the road and the roadside. In order to improve the recognition quality, the antenna of the Radar radiates a vertical polarization signal. The reflection from the roadway is predominantly specular (mirror-like) and therefore does not change the polarization of the reflected signal. On the roadside and near it, there are always local objects and objects exceeding the height of the roadbed. Reflections from such objects, along with the predominant vertical, have also a horizontal component that is, they change the polarization of the signal at the input of the receiving antenna of the radar. This additional feature may be used to refine the current spatial position of the boundaries of the roadway. For this purpose, the receiving antenna is two-polarized (horizontal and vertical). The processing of the received signal is carried out as follows.

FIG. 6 shows the general principle of operation of the claimed invention.

When an object of a complex shape is irradiated with a signal with linear vertical polarization, two reflected signals are received. One of them has a polarization that matches the polarization of the probing signal (i.e., collinear vertical polarization), and the polarization of the second reflected signal is orthogonal to the polarization of the probing signal (cross-horizontal polarization or cross-modulation). To obtain information about road surface boundaries, the ability to receive signals separately with two different polarizations (vertical and horizontal) simultaneously is provided in the radar. The polarization matrix (scattering matrix) is used as a quantitative characteristic of the dependence of the reflectivity of the road and the background (roadside) on the polarization of the irradiating wave. The principle of recognition is based on examining the members of the matrix in the sequence that is implemented when observing the traffic situation. The scattering matrix is obtained as follows.

The electric field E_{Ref} reflected from the target, is represented as:

E_{RefV}=S_{VV}E_{lnV}+S_{HV}E_{lnH}; E_{RefH}=S_{VH}E_{lnV}+S_{HH}E_{lnH},

E_{RefV} and E_{RefH}—vectors characterizing the electric field of reflected waves with vertical and horizontal polarizations;

E_{lnV} and E_{lnH}—vectors characterizing the electric field of incident waves with horizontal and vertical polarizations;

S_{VV}=\sqrt{σ_{VV}}e^{jφ}^{_{VV}}—reflection factor in vertical polarization of the incident wave and vertical polarization of the reflected wave;

S_{HV}=\sqrt{σ_{HV}}e^{jφ}^{_{HV}}—reflection factor in horizontal polarization of the incident wave and vertical polarization of the reflected wave;

S_{VH}=\sqrt{σ_{VH}}e^{jφ}^{_{VH}}—reflection factor in vertical polarization of the incident wave and horizontal polarization of the reflected wave;

S_{HH}=\sqrt{σ_{HH}}e^{jφ}^{_{HH}}—reflection factor in horizontal polarization of the incident wave and horizontal polarization of the reflected wave; φ, σ—are the phase and effective scattering surface of objects for the corresponding polarizations.

Matrix of the type:

$$\vert \begin{matrix}{S}_{VV} & {S}_{HV} \\ {S}_{VH} & {S}_{HH}\end{matrix} \vert = \vert \begin{matrix}\sqrt{{σ}_{VV}} {e}^{j {ϕ}_{VV}} & \sqrt{{σ}_{HV}} {e}^{j {ϕ}_{HV}} \\ \sqrt{{σ}_{VH}} {e}^{j {ϕ}_{VH}} & \sqrt{{σ}_{HH}} {e}^{j {ϕ}_{HH}}\end{matrix} \vert$$

is a polarization matrix and is subject to software processing to isolate a roadway.

Emission of a signal with vertical polarization and subsequent analysis of the reflected signals at four polarizations (two collinear and two cross-over) allows the analysis of the ratio of the amplitudes of signals with collinear and cross-polarizations. According to the results of the analysis of the ratio of the amplitudes, a distinction is made between the roadbed and the roadside.

### REFERENCES

1. Russian Application No.: 2572939.
2. Internet Resource http://Support.Volvocars.com. LDW.
3. Internet Resource http://Support.Volvocars.com. LKA.
4. Internet Resource. System to assist in road traffic http://systemsauto.ru/active/lane_assist.html.

1. A method for ensuring directional stability and safety of a vehicle on a road, comprising the following stages:
obtaining an image of a roadway;
analyzing a presence of marking on the road surface, and, if it is present, processing data about it;
recognizing positions of the marking lines or edge points of the roadway;
calculating a width of the current road lane or an area of the roadbed intended for driving the vehicle and a curvature of said lane and said area of a roadbed;
carrying out a calculation of the position of the vehicle on the current road lane or on the area of the roadbed;
performing a radar probing of a front-side hemisphere of a sector in front of the vehicle with a high resolution along the course of movement by means of an airborne radar with a synthesized aperture;
forming a digital radar image or a radio hologram of the road and objects located on the sides of the road to the right and left of the roadway;
performing automatic recognition on the radar or the radio hologram of a boundary between the road surface and a roadside by analyzing reflected signals in collinear and cross polarizations;
determining a vector speed of the vehicle;
extrapolating a trajectory of motion of vehicle with consideration of the current vector speed;
calculating an assessment of occurrence of an emergency event based on said extrapolation;
activating vehicle security means based on said assessment.

2. The method according to claim 1, characterized in that the current position of the vehicle and the result of extrapolation of the trajectory of its movement on a display of an electronic device are additionally indicated.

3. The method of claim 1, further comprising displaying obstacles on the roadway.

4. The method according to claim 3, characterized in that the analysis of the presence of obstacles takes into account the lanes of movement of the associated and counter-direction and the area of the roadside.

5. The method according to claim 2, characterized in that the electronic device is a head multimedia device of the vehicle.

6. The method according to claim 2, characterized in that the electronic device is an electronic mobile device.

7. The method according to claim 6, characterized in that the mobile device is a smart phone or a tablet or a laptop computer.

8. The method according to claim 5, characterized in that the image on the display of the head multimedia device of the vehicle duplicates information about a trajectory of the vehicle, as well as obstacles on the road, to the electronic mobile device.

9. The method according to claim 1, characterized in that the emergency event is an unintentional displacement of the vehicle into the area of the roadside or a likelihood of a collision with an object, or a skid.

10. The method according to claim 9, characterized in that, depending on a type of the emergency event, an autopilot or an emergency braking system, or an accident prevention system, or a vehicle emergency alarm, or a combination thereof, is activated.

11. A method according to claim 10, characterized in that during activation of the autopilot, a system for holding the vehicle in a traffic lane or in a portion of the road surface of the vehicle is actuated.

12. A device for providing directional stability and safety of a vehicle, comprising a control panel, a digital video camera, a data exchange unit with an onboard computer, a microcontroller, a control unit, a unit for interfacing with actuators, signaling means, vehicle safety means, wherein the data exchange unit with the on-board computer is simultaneously interfaced with the control panel, the microcontroller and the control unit, and the microcontroller is coupled via a digital data bus to the digital video camera and the control unit, an output of the control unit via the unit for interfacing with actuators is connected to the actuating devices that represent means for signaling and safety of the vehicle, wherein the device is additionally provided with a radar with a synthesized aperture, the output of which is connected to the bus of digital data transmission with the microcontroller; a vehicle safety means, such as a mobile communication means, is additionally connected to the unit for interfacing with actuators as a mobile communication means, an alarm and an autopilot; the microcontroller is capable of processing data, obtained from the video camera and the radar, on the basis of which the calculation of a vector speed of motion of the vehicle is performed; the microcontroller performs extrapolation of a trajectory of the vehicle motion based on the current vector speed, calculation of an assessment of occurrence of an emergency event on the basis of said extrapolation and activation of a vehicle security means on the basis of said assessment.
